(19) United States
(12) Patent Application Publication
(10) Pub. No.: US 2013/0277992 A1
(43) Pub. Date: Oct. 24, 2013

(54) ACCESSORY FOR PORTABLE ELECTRONIC DEVICE

(71) Applicant: MICHAEL G. SENOFF, San Diego, CA (US)

(72) Inventor: MICHAEL G. SENOFF, San Diego, CA (US)

(21) Appl. No.: 13/453,375

(22) Filed: Apr. 23, 2012

(51) Int. Cl. B65G 7/12

(52) U.S. Cl. 294/25

(57) ABSTRACT

An insert accessory for a portable electronic device that is allows for a user to hold an electronic device configured with the insert accessory using only a finger and the palm of the hand in order to free up use of user's thumb in order to interact with the portable electronic device using only one hand. The insert accessory is adhered to the back surface of a portable electronic device and has a movable finger sized tab that rotates sufficiently to allow a finger to pass through the tab and enable the user to hold the portable electronic device without the use of his or her thumb. Once so held, the user then has the freedom to operate the controls the portable electronic device with the thumb of the same hand that is holding the portable electronic device.

### FIELD OF THE INVENTION

The present invention relates generally to accessories for portable electronic devices. The present invention is more particularly though not exclusively directed to a device allowing a user to hold a portable electronic device without the use of his or her thumb and also without the product dropping or slipping from the user's hands. The present invention provides the ability to both securely hold a portable device, and operate it with the same hand.

### BACKGROUND OF THE INVENTION

Over the past few decades, the use of portable electronic products has become increasingly common. Indeed, these devices are so common that it is not unusual for a person to use their personal electronic device while doing other activities. Unfortunately, most personal electronic devices require the use of two hands, thus making it difficult to use the electronic device while doing things that require use of one or more hands.

It is generally known in the art to affix a handle or hanger onto the back of a portable electronic device using an adhesive. For example, U.S. Pat. No. 6,427,293 discloses a metallic clip that extends from an adhesive mounted base with a semi-circular metallic “D” ring attached to it. The base is attached to an electronic device so that the ring can be used to suspend the electronic device. This clip does not facilitate the holding of the electronic device, and is intended only as a means to secure the electronics when it cannot be held in the user's hand.

Similarly, U.S. Pat. No. 6,550,108 discloses a device with a self-adhesive based with a ring that pivots from the base. This device includes a rigid “D” ring that pivots from a large base attached to the backside of a portable electronic device. This device, however, is bulky and the “D” ring cannot be positioned flush with the backside of the electronic device. As a result, the “D” ring is susceptible to snagging when not in use.

These previously available devices are insufficient and do not address the desire for singe-handed operation of the device, because there is no secure manner by which the user may grip the device while simultaneously allowing the thumb of the same hand to interact with the device. As a result, anyone using a cell phone, electronic game counsel, or music player, must use both hands to securely operate the device; one to hold the device, and another to actuate the controls on the device. To the extent any prior art has attempted to address this specific concern, the prior art failed to provide a design that is robust, easy and affordable to manufacture, and slim in profile to facilitate storage.

In light of the above, it would be advantageous to provide an accessory for a portable electronic device that acts as a accessory for portable electronic devices and allows for a user to hold an electronic device configured with the insert accessory using only a finger and the palm of the hand in order to free up use of user's thumb in order to interact with the portable electronic device using only one hand. It would also be advantageous to provide an insert accessory, collapsible to a low profile shape that enables quick and easy storage of the electronic storage device while configured with the insert accessory. It would be further advantageous to provide an accessory having a design that is easy to manufacture, yet robust when in use by the user.

### SUMMARY OF THE INVENTION

The accessory for portable electronic devices of the present invention allows for a user to hold an electronic device configured with the insert accessory, using a single finger and the palm of the hand, freeing the thumb to interact with the portable electronic device using only one hand. The accessory for portable electronic device includes a base that adheres to the back surface of a portable electronic device, and is formed with a movable finger-sized tab that rotates sufficiently to allow a finger to pass through the tab and enable the user to hold the portable electronic device without the use of his or her thumb. Once so held, the user then has the freedom to operate the controls of the portable electronic device with the thumb of the same hand that is holding the portable electronic device thereby eliminating the need for using two hands to operate the portable electronic device.

### BRIEF DESCRIPTION OF THE DRAWING

The nature, objects, and advantages of the accessory for portable electronic devices of the present invention will become more apparent to those skilled in the art after considering the following detailed description in connection with the accompanying drawings, in which like reference numerals designate like parts throughout, and wherein:

FIG. 1 is a front isometric view of the accessory for portable electronic devices depicting the moveable tab in stowed position, flush with thin body of the accessory for portable electronic devices;

FIG. 2 is a front isometric view of the accessory for portable electronic devices with tab rotated away and extended from the thin body, allowing insertion of a finger;

FIG. 3 is back isometric view of the accessory for portable electronic devices, depicting a possible placement of adhesive layers, and their orientation with respect to the moveable tab so as to allow the moveable tab to be rotated away from the thin body for use;

FIG. 4 is a view of a typical portable electronic device onto which the accessory for portable electronic devices may be fitted, and the placement of a electronic device's controls;

FIG. 5 is a side view of the accessory for portable electronic devices, depicting the removal of the protective layer, overlying the adhesive layer and a possible placement for the accessory for portable electronic devices;

FIG. 6 is a side view of the accessory for portable electronic devices showing the relative thicknesses of the accessory for portable electronic devices and an electronic device, in addition to a possible placement of the accessory for portable electronic devices;

FIG. 7 is a side view of the accessory for portable electronic devices as the moveable tab is rotated away from the thin body of the accessory for portable electronic devices into a position for use;

FIG. 8 is a back view of accessory for portable electronic devices in use where the user's finger is inserted through the moveable tab in the thin body (shown in dashed lines), allowing one-handed use of the portable electronic device;

FIG. 9 is a front view of accessory for portable electronic devices in use with a finger inserted through the hole in the moveable tab, and the placement of the accessory for portable electronic devices on the back of a portable electronic device;

FIG. 10a is a side view of the accessory for portable electronic devices depicting the manner in which the moveable tab is rotated back toward the portable electronic device when not in use;

FIG. 10b is a side view of the accessory for portable electronic devices depicting the profile of the accessory for portable electronic devices when the moveable tab is not in use and after the moveable tab has been returned to a position flush with the thin body;

FIG. 11a is a front view of the accessory for portable electronic devices installed on the back of the portable electronic device in a position transverse to the longitudinal axis of the portable electronic device toward the bottom of the portable electronic device;

FIG. 11b is a front view of the accessory for portable electronic devices installed on the back of the portable electronic device in a position parallel to the longitudinal axis of the portable electronic device toward the bottom of the portable electronic device;

FIG. 11c is a front view of the accessory for portable electronic devices installed on the back of the portable electronic device in a position parallel to the longitudinal axis of the portable electronic device toward the top of the portable electronic device;

FIG. 12 is a front view of an alternate embodiment the accessory for portable electronic devices with an oval shape and a manufacturer's logo imprinted upon the accessory for portable electronic devices;

FIG. 13 is a front view of an alternate embodiment the accessory for portable electronic devices with an oval shape and a different manufacturer's logo imprinted upon the accessory for portable electronic devices;

FIG. 14 is a front view of an alternate embodiment of the accessory for portable electronic devices with two movable tabs, allowing a finger to be inserted through both moveable tabs, ensuring more secure implementation;

FIG. 15 is a side view of an alternate embodiment of the accessory for portable electronic devices with two movable tabs and the direction in which each is rotated out for use and to the position flush with the thin body when not in use.

FIG. 16 is a side view of an alternative embodiment of the accessory for portable electronic devices with a retainer and a leg affixed to a ring, allowing the accessory to be fit between a portable electronic device and a protective case; and

FIG. 17 is an isometric front view of the alternative embodiment of the accessory for portable electronic devices of FIG. 16, as installed between a portable electronic device and a protective case.

### DETAILED DESCRIPTION OF A PREFERRED EMBODIMENT

As to more detailed descriptions of the present invention, as illustrated in FIG. 1, an accessory for portable electronic devices 100 consists of a thin body, or base, 102 with a front surface 104, a back surface 106, a thickness 108 and a perimeter shape 110 that is, in a preferred embodiment, generally rectangular. It will be appreciated by those skilled in the art that the perimeter shape 110 can be in any shape, including but not limited to square, rectangular, circular, oval or any other shape sized not to exceed the perimeter dimensions of any portable electronic device.

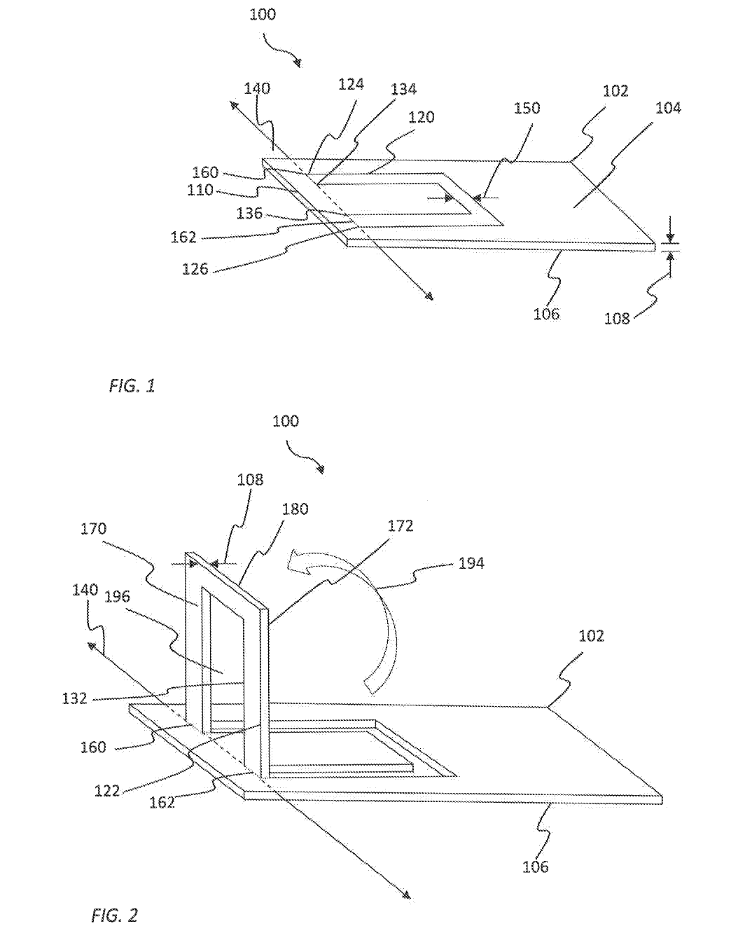

The thin body 102 has an outer cut 120 and an inner cut 130 wherein the outer cut 120 and inner cut 130 pass through the thin body 102 from the front surface 104 to the back surface 106. The outer cut 120 has an outer cut profile 122 with an outer cut profile first end 124 and an outer cut profile second end 126. The outer cut profile 122, shown in FIG. 2, extends from the outer cut profile first end 124 to the outer cut profile second end 126.

The inner cut 130 has an inner cut profile 132 with an inner cut profile first end 134 and an inner cut profile second end 136. The inner cut profile 132 extends from the inner cut profile first end 134 to the inner cut profile second end 136.

The outer cut profile 122 is situated with respect to the inner cut profile 132 to ensure that a minimum cut distance 150 is maintained between the outer cut profile 122 and the inner cut profile 132.

The thin body 102 has a folding axis 140, shown in dashed lines where it passes through thin body 102. The outer cut profile first end 124, the outer cut profile second end 126, the inner cut profile first end 134 and the inner cut profile second end 136 are each located along the folding axis 140 in such a manner to create a first fold line 160 and a second fold line 162, both shown in dotted lines. The first fold line 160 runs along the folding axis 140 between the outer cut profile first end 124 and the inner cut profile first end 134. The second fold line 162 runs along the folding axis 140 between the outer cut profile second end 126 and the inner cut profile second end 136.

As can be seen on FIG. 2, the outer cut profile 122, the inner cut profile 132, the first fold line 160 and the second fold line 162 enclose a front area 170 on the front surface 104 and a back area 172 on the back surface 106 of the moveable tab 180. The front area 170 and back area 172 and thickness 108 create a moveable tab 180 that can be rotated away from the plane of the front surface 104 of the thin body 102 in a first rotational direction 194.

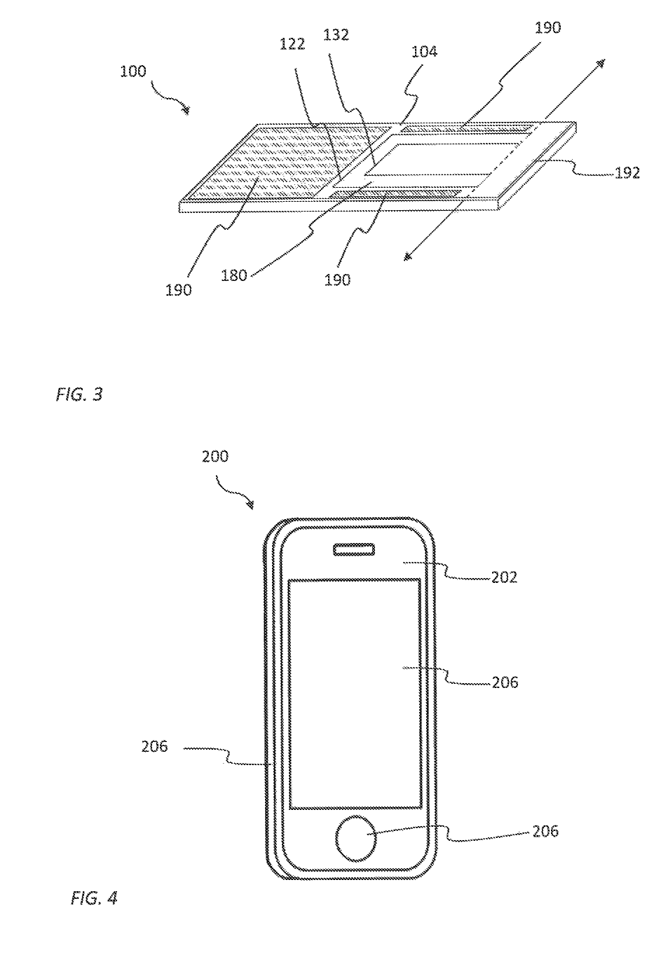

Referring to FIG. 3, a portion of the back surface 104 is coated with an adhesive layer 190 and a protective layer 192. The adhesive layer 190 is made of a material sufficient to adhere the back surface 106 of the accessory for portable electronic devices 100 to a portable electronic device 200, depicted in FIG. 4. The adhesive layer 190 is not located on any portion of the back area 172 to ensure that the movable tab 180 cannot be adhered to the portable electronic device 200. The protective layer 192 is attached to the adhesive layer 190 and the remaining back surface 106 that does not have any adhesive layer 190 bonded to it. The protective layer 192 acts to protect the adhesive layer 190 and prevent the adhesive layer 190 from accidentally bonding to any material until the accessory for portable electronic devices 100 is ready for use.

It is to be appreciated by those skilled in the art that adhesive layer 190 is intended to bond enough of back surface 104 of thin body 102 in order to maintain a secure connection to an electronic device 200 (shown in FIG. 4) during use. As such, the amount of back surface 104 having adhesive attached to it may be variable, and adhesive layer 190 may be formed in patches as shown in FIG. 3, or an adhesive layer may cover the entirety of back surface 104 with the exception of back area 172.

Referring now to FIG. 4, a typical portable electronic device 200 has a front surface 202 and a back surface 204 with a control touch screen surface 206 and control buttons 208 generally located on the front surface 204.

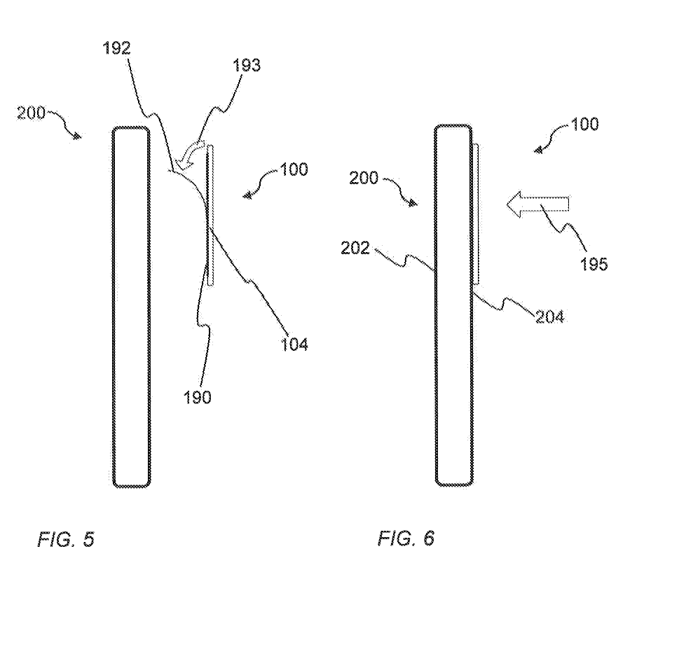

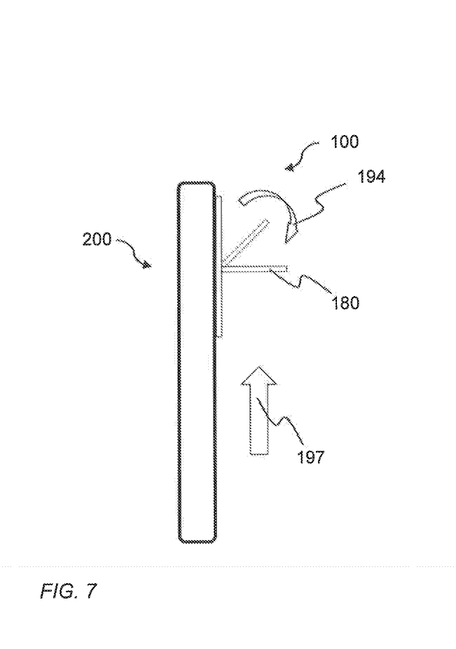

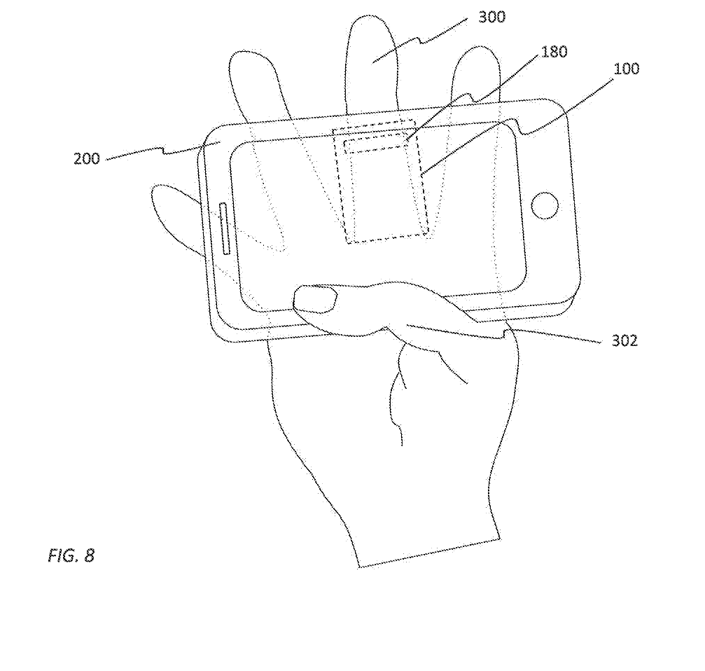

FIGS. 5 through 7 generally show the process of how to use the accessory for portable electronic devices 100. First, the user removes protective layer 192 in order to expose the adhesive layer 190. In a preferred embodiment, the protective layer is peeled from the back surface 104 in a peel direction 193. The back surface 104 of the accessory for portable electronic devices 100 is then adhered to the portable electronic device 200 by contacting the exposed adhesive layer 192 to the back surface 204 of the portable electronic device 200 and pressing firmly by the user in direction 195. The movable tab 180 is then folded at the first fold line 160 and the second fold line 162 along the folding axis 140 in a first rotational direction 194 sufficiently to create a finger sized opening 196. A finger 300 shown in FIG. 8, is then inserted through the finger sized opening 196 in an insert direction 197 so as to enable the user firmly hold the portable electronic device 200 by only using finger 300 and the palm of the user's hand.

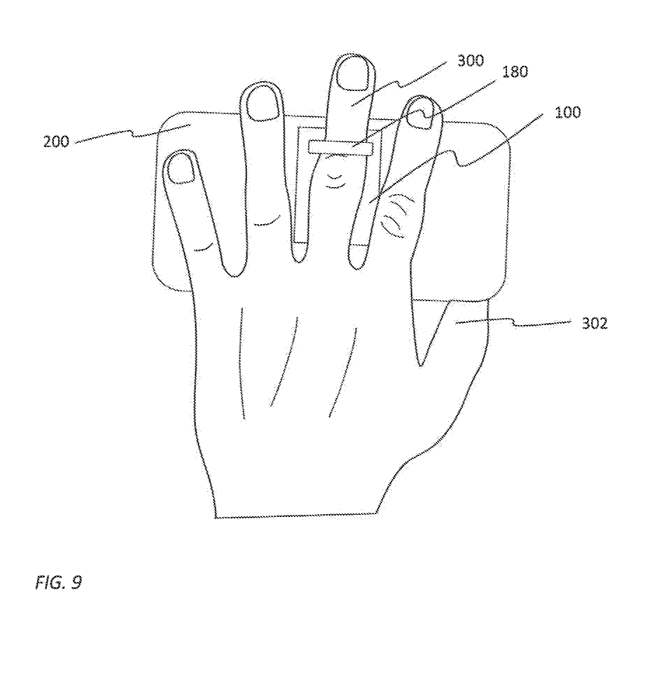

FIGS. 8 and 9 depict the accessory for portable electronic devices in use, with finger 300 inserted in the moveable tab 180. FIG. 8 depicts the relative position of portable electronic device 200 situated in the user's hand and with the accessory for portable electronic devices 100 shown in phantom. In this configuration, the user will have free use of his or her thumb 302 to interact with the control touch screen surface 206, control button 208, or other similar controls of the typical portable electronic device 200.

Referring to FIG. 9, the user's finger 300 is shown inserted through the hole 196 in the moveable tab 180, securing the portable electronic device 200 in place. The thumb 302 in then free to interact with the controls on the portable electronic device 200. As a result, the user will have free use of his or her other hand to hold other objects such as a child's hand or an umbrella while still being capable of operating the portable electronic device. The present invention is in no way intended to be limited to use of portable electronic devices with touch screen controls. Any combination of controls used in portable electronic devices such as buttons, knobs, dials, etc. could be operated with a thumb when any portable electronic device is configured with the present invention.

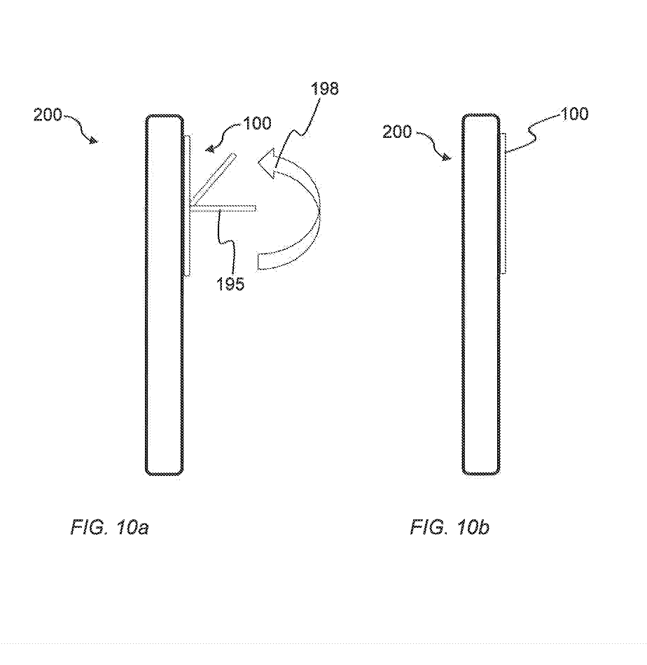

Referring to FIGS. 10a and 10b, when the user is finished using the portable electronic device 200, the user then simply folds the movable tab 180 in a second rotational direction 198, opposite to the first rotational direction 194, until the movable tab 180 is returned to its original position flush with the front surface 104 and back surface 106 of the thin body 102. Once so configured, the accessory for portable electronic devices 100 will return to a thickness 108 that is sufficiently thin to enable quick and easy storage of the portable electronic device.

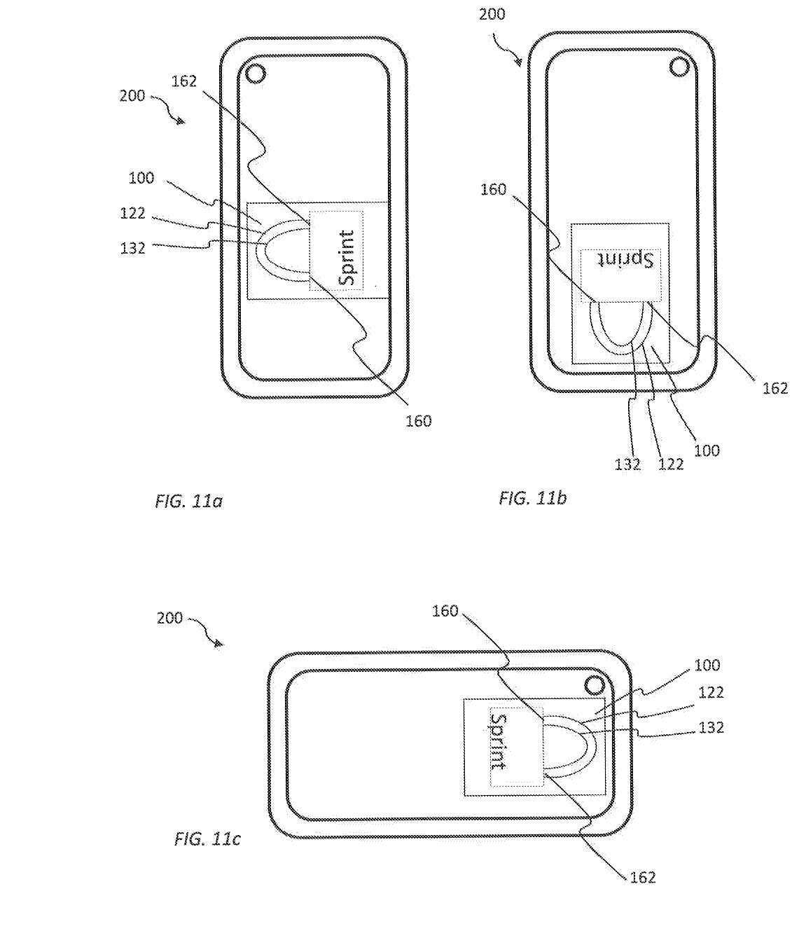

The present invention anticipates that users will have different sized hands, fingers, as well as different sized portable electronic devices. Thus, as depicted in FIGS. 11a through 11c, the accessory for portable electronic devices 100 can be oriented in numerous different directions to the back surface 204 of a portable electronic device 200. FIGS. 11a through 11c also demonstrate an alternative preferred embodiment in which the outer cut profile 122 and the inner cut profile 132 are generally curved to generally conform to a cross-section of a typical finger 300. The minimum cut distance 150 between the outer cut profile 122 and the inner cut profile 132 is sufficient to ensure that the movable tab 180 is large enough to easily grab, fold, and insert a finger 300 through the resulting finger sized opening 196, yet remain structurally sound when in use. However, it will be appreciated to those skilled in the art that a wide variety of geometries can be used to create a finger sized opening 196. These geometries can be created by varying the path of the outer cut profile 122, the inner cut profile 132, or both. Depending on the geometry used, the minimum cut distance 150 is either varied along the length of the outer cut profile 122 or it is fixed.

The present invention is inexpensive to manufacture as the thin body 102 can be made of a singular material, such as semi-flexible plastic or rubber material and the perimeter shape 110, the outer cut 120 and the inner cut 130 each can be created by a die cut process, or other processes known in the art.

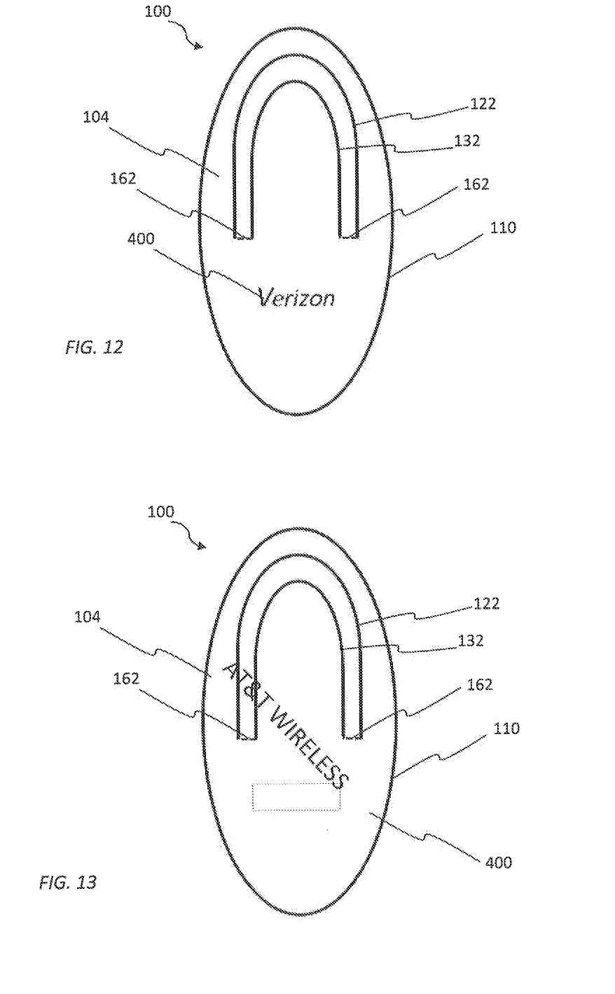

As seen in FIGS. 12 and 13, in another embodiment of the present invention, the accessory for portable electronic devices 100 is sized with a perimeter shape 110 sufficiently large to accommodate a logo 400 printed on the front surface 104 of the thin body 102. In this embodiment, the perimeter shape 110 is generally oval instead of rectangular. It is perceived that another utility of the present invention will be appreciated by telecommunications companies and other companies offering portable electronic devices for sale and that such companies would either offer the present invention as an accessory for purchase or as a promotional giveaway to entice a purchase of their portable electronic devices. In either event, such companies would likely desire to print their logo on the accessory for portable electronic devices 100.

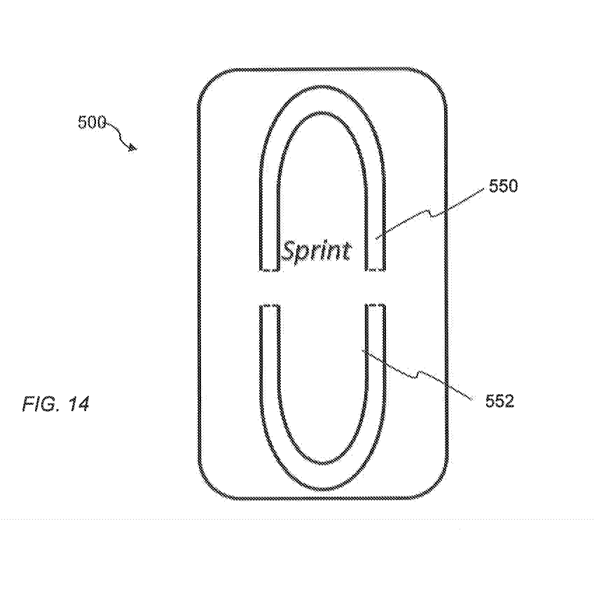

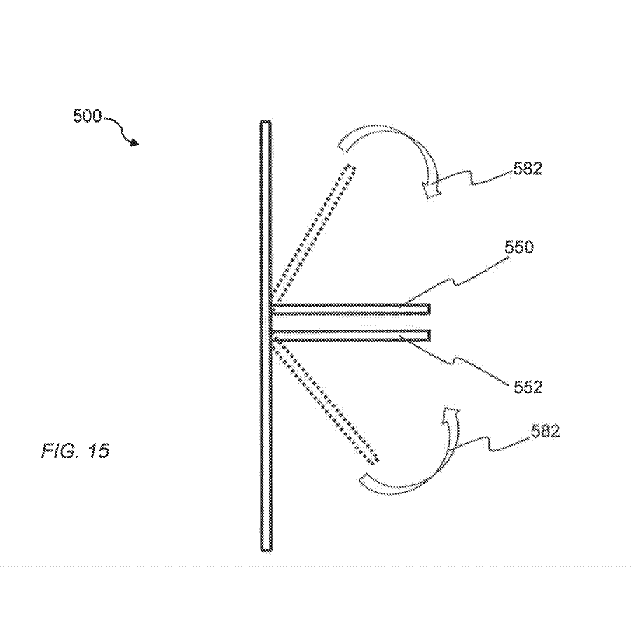

In another embodiment of the present invention, an accessory for portable electronic devices 500 is depicted in FIGS. 14 through 15. FIG. 14 is a front view of the accessory for portable electronic devices 500 with a first moveable tab 550 and a second movable tab 552. FIG. 15 is a side view of the accessory for portable electronic devices 500 showing the first movable tab 550 being rotated in a direction 580 and the second movable tab 552 being rotated in an opposite direction 582 until both first movable tab and second movable tab have each revealed an opening sized to receive a finger. The addition of a second movable tab 552 to the accessory for portable electronic devices 500 acts to reinforce the first moveable tab by absorbing a portion of the load created by a user's finger when the accessory for portable electronic devices is in use that would otherwise be borne solely by the first movable tab.

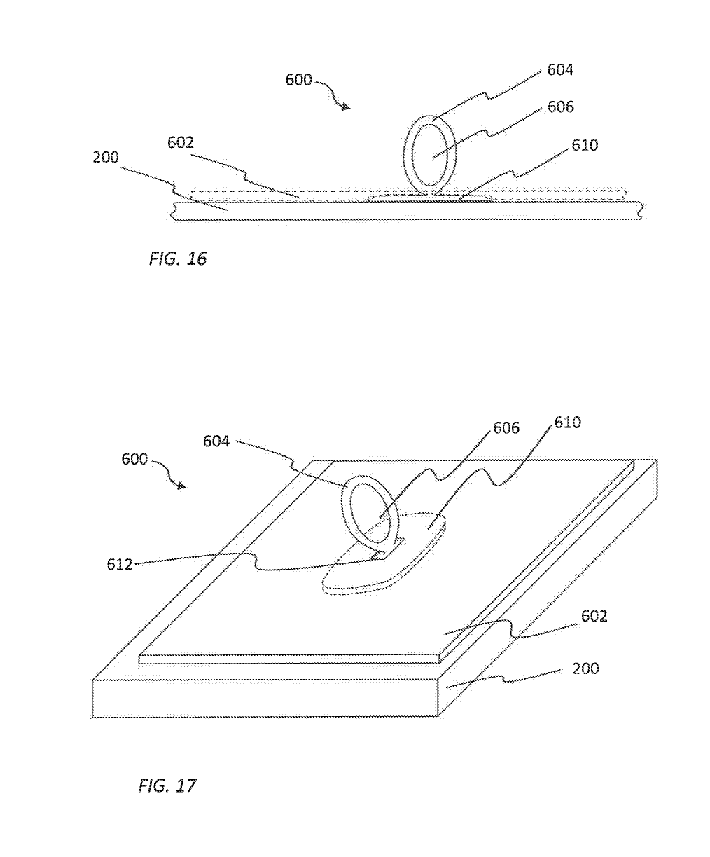

Referring to FIG. 16, an alternative embodiment of the accessory for portable electronic devices of the present invention is generally designated 600. Accessory 600 is formed with ring 604, hole 606, and retainer 610. Accessory 600 is contemplated for use with a protective case 602 in use with portable electronic device 200.

Referring now to FIG. 17, accessory 600 is shown connected to the protective case 602 of the portable electronic device. In this Figure, only a portion of protective case 602 and portable device 200 are depicted as a cut-away from the larger assembly. Protective case 602 is formed similar to any one of the many protective cases commercially available and form-fitted to a particular electronic device. Accessory 600 is formed with ring 604 and hole 606, accommodating finger 300. It is to be appreciated that hole 606 may be sized to accommodate any number of finger 300 sizes.

Ring 604 is formed to retainer 610, securing the accessory 600 to the inside of protective case 602. In use, ring 604 is compressed laterally, allowing it to pass through slot 612 to the outer side of protective case 602. Slot 612 in protective case 602 is formed large enough to pass ring 606, but not large enough to pass retainer 610, allowing the user to remove the entire accessory 600 when its use is not desired, yet providing a secure connection between finger 300 and portable electronic device 200. Slot 612 may be formed into protective case 602 during construction or a user can manually cut a slot 612 to accommodate accessory 600. The connection between retainer 610 and protective case 602 further allows a flexible connection between portable device 200 and finger 300, freeing the user's opposite hand as before. In use, retainer 610 is fit securely between protective case 602 and portable electronic device 200.

This embodiment is not contemplated for use with an adhesive layer analogous to adhesive layer 190 in previous embodiments, but an adhesive may be employed as needed between retainer 610 and portable electronic device 200.

This alternative embodiment contemplates a semi-rigid plastic, rubber, or similar construction of accessory 600, allowing the user to compress a larger ring 604 and fit it through a smaller slot 612. This further improves the security of the connection to finger 300. Similar to previous embodiments, the flexible nature of accessory 600 allows ring 604 to fold flat against the back of protective case 602, keeping ring 604 out of the way when inserted or removed from the user's pocket or bag.

While there have been shown what are presently considered to be preferred embodiments of the present invention, it will be apparent to those skilled in the art that various changes and modifications can be made herein without departing from the scope and spirit of the invention.

1. An accessory for portable electronic devices, comprising:
a base having a front surface and a back surface and formed with a movable tab that is positionable from a first position wherein said tab is co-planar with said base, and a second position wherein said tab extends at an angle from said front base;
an adhesive layer on said back of said base attachable to a surface of a portable electronic device; and
a case formed with a slot, said case at least partially surrounds said portable electronic device;
wherein said tab is formed with an aperture to receive a portion of a user's finger and wherein said adhesive layer on said base is adhered to said portable electronic device, and said tab extends from said base through said slot.

2. The accessory for portable electronic devices of claim 1, wherein said tab is formed with a “D” shape.

3. The accessory for portable electronic devices of claim 1, wherein said tab is formed with a “O” shape.

4. (canceled)

5. An accessory for portable electronic devices, comprising:
a base having a front surface and a back surface and formed with a first movable tab that is positionable from a first position wherein said first movable tab is co-planar with said base, and a second position wherein said tab extends at an angle from said front base and formed with a second movable tab that is positionable from a first position wherein said tab is co-planar with said base, and a second position wherein said second movable tab extends at an angle from said front base;
an adhesive on said back of said base attachable to a surface of a portable electronic device; and
a case formed with a slot, said case at least partially surrounds said portable electronic device;
wherein said first movable tab and said second movable tab are formed with an aperture to receive a portion of a user's finger when in said second position and;
wherein said adhesive layer on said base is adhered to said portable electronic device, and said tabs extend from said base through said slot.

6. The accessory for portable electronic devices of claim 5, wherein each said tab is formed with a “D” shape.

7. The accessory for portable electronic devices of claim 5, wherein each said tab is formed with a “O” shape.

8. (canceled)

9. (canceled)

10. An accessory for portable electronic devices, comprising:
a ring sized to accept a least a portion of a finger;
a retainer formed generally flat and larger than a slot formed in the back of a case for a portable electronic device;
a flexible post extending through said slot, connecting said ring to a retainer, wherein the ring is passed through a slot in a case and said retainer lies flat between said case and said portable electronic device.

11. The accessory for portable electronic devices of claim 10, wherein said slot is preformed in said case.

12. The accessory for portable electronic devices of claim 10, wherein said ring, post, and retainer are made of rubber.

13. The accessory for portable electronic devices of claim 10, wherein an adhesive is used between said retainer and said portable electronic device.
